(19) United States
(12) Patent Application Publication
(10) Pub. No.: US 2015/0116276 A1
(43) Pub. Date: Apr. 30, 2015

(54) PROJECTOR

(71) Applicant: FUNAI ELECTRIC CO., LTD., Osaka (JP)

(72) Inventors: Shintaro IZUKAWA, Kobe-shi (JP); Ken NISHIOKA, Osaka (JP); Atsuhiko CHIKAOKA, Kyoto-shi (JP)

(21) Appl. No.: 14/519,184

(22) Filed: Oct. 21, 2014

(30) Foreign Application Priority Data
Oct. 31, 2013 (JP) 2013-227539

(51) Int. Cl. G06F 3/042

(52) U.S. Cl. CPC G06F 3/0421
USPC 345/175

(57) ABSTRACT

Provided is a projector that projects an image onto a screen, and detects a touch of an operating object on the screen and includes: a light source that emits laser light; a projecting unit configured to project the image onto the screen by scanning the laser light from the light source toward the screen; a light receiving unit configured to detect the laser light reflected from the operating object; and a control unit configured to determine that the operating object has touched the screen, based on change in the laser light detected by the light receiving unit.

### CROSS REFERENCE TO RELATED APPLICATION

The present application is based on and claims priority of Japanese Patent Application No. 2013-227539 filed on Oct. 31, 2013. The entire disclosure of the above-identified application, including the specification, drawings and claims is incorporated herein by reference in its entirety.

### FIELD

The present invention relates to a projector that projects an image onto a projection screen, and detects a touch of an operating object on the projection screen.

### BACKGROUND

Projectors that project an image onto a projection screen by scanning a laser light on the projection screen are known. In recent years, projectors having virtual user interfaces (VUIs) have become known (for example, see Patent Literature (PTL) 1). The VUI is a virtual user interface allowing a user to perform an operation on an image projected onto a projection screen (for example, an image of a keyboard or an operating panel), using an operating object such as a stylus.

Such projector includes a light source that emits laser light; a scanning unit that scans the laser light from the light source toward the projection screen; a light receiving unit that detects the laser light reflected from the operating object; and a control unit that determines that the operating object has touched the projection screen, when the light receiving unit detects the laser light. For example, the user can perform a touch operation on a keyboard by touching, using an operating object, a projection screen on which an image of the keyboard is projected.

### CITATION LIST

### Patent Literature

### [PTL 1] Japanese Unexamined Patent Application Publication No. 2009-258569

### SUMMARY

### Technical Problem

The conventional projectors have the following problems. As described above, the control unit included in the projectors determines that the operating object has touched the projection screen when the light receiving unit detects the laser light. Thus, when the light receiving unit detects the laser light while the operating object is approaching the projection screen, the control unit may erroneously determine that the operating object has touched the projection screen. As a result, touching of the operating object on the projection screen cannot be accurately detected.

The present invention has been conceived to solve such problems, and has an object of providing a projector that can accurately detect a touch of an operating object on a projection screen.

### Solution to Problem

In order to achieve the object, a projector according to an aspect of the present invention is a projector that projects an image onto a projection screen, and detects a touch of an operating object on the projection screen, the projector including: a light source that emits laser light; a projecting unit configured to project the image onto the projection screen by scanning the laser light from the light source toward the projection screen; a light receiving unit configured to detect the laser light reflected from the operating object; and a control unit configured to determine that the operating object has touched the projection screen, based on change in the laser light detected by the light receiving unit.

When the operating object has touched the projection screen, change in the laser light detected by the light receiving unit can be traced. According to an aspect of the present invention, since the control unit determines that the operating object has touched the projection screen based on such change in the laser light, it is possible to prevent the control unit from erroneously determining the touch, for example, while the operating object is approaching the operating object. As a result, touching of the operating object on the projection screen can be accurately detected.

For example, in the projector according to the aspect of the present invention, the control unit may be configured to obtain an amount of the laser light detected by the light receiving unit, and determine that the operating object has touched the projection screen when the detected amount is constant during a first period.

When the operating object touches the projection screen, the detected amount obtained by the control unit becomes constant. According to an aspect of the present invention, since the control unit determines that the operating object has touched the projection screen when the detected amount is constant during the first period, touching of the operating object on the projection screen can be accurately detected.

For example, in the projector according to the aspect of the present invention, the control unit may be further configured to determine that the operating object has touched the projection screen, when the detected amount is constant during a second period shorter than the first period and starts to decrease after the second period.

According to the aspect of the present invention, the control unit determines that the operating object has touched the projection screen, when the detected amount is constant during a second period shorter than the first period and starts to decrease after the second period. Accordingly, for example, when the operating object starts to move away from the projection screen immediately after touching the projection screen, the control unit can determine that the operating object has touched the projection screen.

For example, in the projector according to the aspect of the present invention, the detected amount may include a detection time during which the light receiving unit detects the laser light per frame of the image.

According to this aspect, the detected amount may include the detection time of the laser light.

For example, in the projector according to an aspect of the present invention, the detected amount may include a peak value of an amount of the laser light detected by the light receiving unit per frame of the image.

According to this aspect, the detected amount may include the detected peak value of the amount of the laser light.

For example, the projector according to the aspect of the present invention may further include a storage unit configured to prestore a reference detection time during which the light receiving unit is to detect the laser light per frame of the image, when the operating object touches the screen, wherein the control unit may be configured to obtain a detection time during which the light receiving unit detects the laser light per frame of the image, and determine that the operating object has touched the projection screen when the obtained detection time is equal to the reference detection time prestored by the storage unit.

According to this aspect, the control unit determines that the operating object has touched the projection screen when the obtained detection time is equal to the reference detection time prestored by the storage unit For example, when the size (diameter) of an operating object, such as a stylus, dedicated to a projector is predetermined, prestoring, by the storage unit, the reference detection time during which the laser light reflected from the operating object needs to be detected enables accurate detection of the touch of the operating object on the projection screen.

For example, in the projector according to the aspect of the present invention, the control unit may be configured to obtain a variation in amount of the laser light detected by the light receiving unit, and determine that the operating object has touched the projection screen based on a comparison between the obtained variation in the detected amount and a predetermined threshold.

According to this aspect, the control unit determines that the operating object has touched the projection screen based on the comparison between the obtained variation in detected amount and the predetermined threshold. Thus, touching of the operating object on the projection screen can be accurately detected when, for example, the variation in detected amount is temporally abruptly changed.

For example, in the projector according to the aspect of the present invention, the detected amount may include a detection time during which the light receiving unit detects the laser light per frame of the image, and the control unit may be configured to obtain a variation in the detection time, and determine that the operating object has touched the projection screen when the obtained variation in the detection time is lower than the predetermined threshold.

When the detected amount includes the detection time of the laser light and the operating object touches the projection screen, the variation in detection time abruptly decreases. According to an aspect of the present invention, since the control unit determines that the operating object has touched the projection screen when the obtained variation in detection time is lower than the predetermined threshold, touching of the operating object on the projection screen can be accurately detected.

For example, in the projector according to the aspect of the present invention, the detected amount may include a peak value of an amount of the laser light detected by the light receiving unit per frame of the image, and the control unit may be configured to obtain a variation in the detected peak value, and determine that the operating object has touched the projection screen when the obtained variation in the detected peak value exceeds the predetermined threshold.

When the detected amount includes the detected peak value of the amount of the laser light and the operating object touches the projection screen, the variation in detected peak value abruptly increases. According to the aspect of the present invention, since the control unit determines that the operating object has touched the projection screen when the obtained variation in detected peak value exceeds the predetermined threshold, touching of the operating object on the projection screen can be accurately detected.

The present invention can be implemented not only as a projector including such characteristic control unit but also as a control method including processes to be performed by the control unit included in the projector as steps. Furthermore, the present invention can be implemented as a program causing a computer to function as the control unit included in the projector, or to execute such characteristic steps included in the control method. Such program is obviously distributed through non-transitory computer-readable recording media such as a compact disc-read only memory (CD-ROM) or via a communication network such as the Internet.

### Advantageous Effects

The projector according to an aspect of the present invention can accurately detect that the operating object has touched the projection screen.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a perspective view schematically illustrating a projector according to Embodiment 1.

FIG. 2 is a block diagram illustrating the functional configuration of a projector main unit.

FIG. 3 schematically illustrates a relationship between moving of an operating object and a detection time.

FIG. 4 schematically illustrates a relationship between moving of an operating object and a detected peak value.

FIG. 5 is a flowchart indicating procedure of the method for determining a touch by a control unit in the projector according to Embodiment 1.

FIG. 6 is a graph indicating a relationship between a frame of an image and a detection time when the detection time is constant during the first period and decreases after the first period.

FIG. 7 is a graph indicating a relationship between a frame of an image and a detection time when the detection time is constant during the second period and decreases after the second period.

FIG. 8 is a flowchart indicating procedure of the method for determining a touch by a control unit in a projector according to Embodiment 2.

FIG. 9 is a graph indicating a relationship between a frame of an image and a detected peak value when the detected peak value is constant during the first period and decreases after the first period.

FIG. 10 is a graph indicating a relationship between a frame of an image and a detected peak value when the detected peak value is constant during the second period and decreases after the second period.

FIG. 11 is a flowchart indicating procedure of the method for determining a touch by a control unit in a projector according to Embodiment 3.

FIG. 12 is a flowchart indicating procedure of the method for determining a touch by a control unit in a projector according to Embodiment 4.

FIG. 13 is a graph indicating the temporal variation in detection time.

FIG. 14 is a flowchart indicating procedure of the method for determining a touch by a control unit in a projector according to Embodiment 5.

FIG. 15 is a graph indicating the temporal variation in detected peak value.

### DESCRIPTION OF EMBODIMENTS

Embodiments according to the present invention will be described in detail with reference to the drawings. Embodiments to be described hereinafter are all preferable embodiments of the present invention. The values, shapes, materials, constituent elements, positions and connections of the constituent elements, steps, and orders of the steps indicated in Embodiments are examples, and do not limit the present invention. The present invention is specified by the claims. Thus, the constituent elements in Embodiments that are not described in independent claims are not always necessary to solve the problems of the present invention but described for preferred embodiments of the present invention.

### Embodiment 1

### Schematic Configuration of Projector

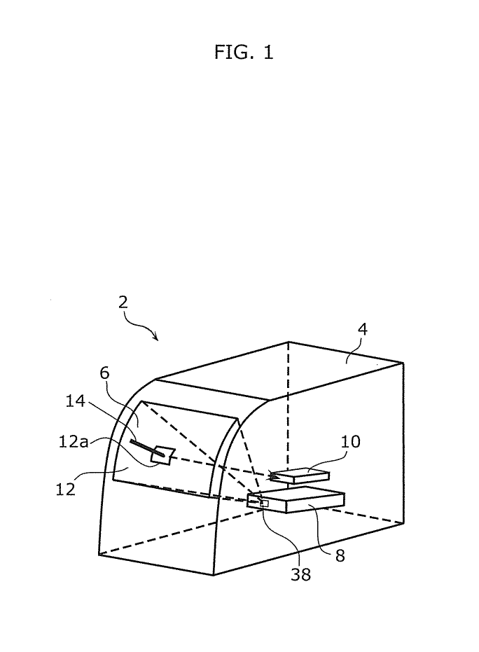

The schematic configuration of a projector 2 according to Embodiment 1 will be described with reference to FIG. 1. FIG. 1 is a perspective view schematically illustrating the projector 2 according to Embodiment 1.

As illustrated in FIG. 1, the projector 2 includes a housing 4, a screen 6 (projection screen), a projector main unit 8, and a light receiving unit 10. The projector 2 is a projector that has the VUI and scans laser light. Furthermore, the projector 2 is a rear projection projector that projects an image 12 on the screen 6 from the rear of the screen 6.

The housing 4 houses the projector main unit 8 and the light receiving unit 10. The front surface of the housing 4 has a projection. The housing 4 is placed on, for example, a table.

The screen 6 is provided in the front surface of the housing 4. The screen 6 transmits and diffuses the laser light from the projector main unit 8, from the rear to the front of the screen 6 (that is, from the projector main unit 8 to an operating object 14). Specifically, the screen 6 contains a translucent resin (for example, chloroethylene) for transmitting laser light. Furthermore, the screen 6 includes diffusing lenses (not illustrated) for diffusing laser light. The screen 6 has a projection corresponding to, for example, the shape of the front surface of the housing 4.

The projector main unit 8 is disposed rear of the screen 6. The projector main unit 8 projects the image 12 (for example, an image of a keyboard or an operating panel) on the screen 6 by scanning the laser light toward the screen 6. The functional configuration of the projector main unit 8 will be described later.

The light receiving unit 10 is disposed rear of the screen 6. The light receiving unit 10 includes, for example, a photodiode, and detects (receives) laser light reflected from the operating object 14 (for example, a stylus or the fingers of the user). The light receiving unit 10 transmits detection information on the detected laser light, to a control unit 16 (to be described later) of the projector main unit 8.

The projector 2 is used, for example, in the following manner. The laser light emitted from the projector main unit 8 is scanned toward the screen 6, so that the image 12 is projected onto the screen 6. For example, when the image 12 of the keyboard is projected onto the screen 6 and the user touches an image 12a of an input key included in the image 12, using the operating object 14, the input key can be operated. The screen 6 is touched by the operating object 14 from the front of the screen 6.

### [Functional Configuration of Projector Main Unit]

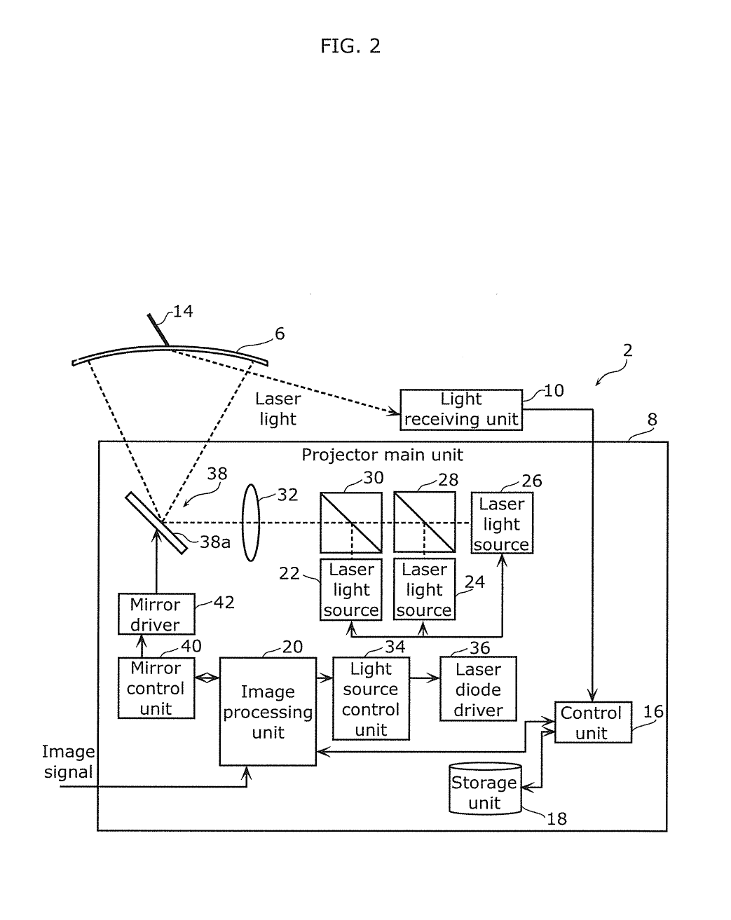

Next, the functional configuration of the projector main unit 8 will be described with reference to FIG. 2. FIG. 2 is a block diagram illustrating the functional configuration of the projector main unit 8.

As illustrated in FIG. 2, the projector main unit 8 includes a control unit 16, a storage unit 18, an image processing unit 20, three laser light sources 22, 24, and 26 (light sources), two dichroic mirrors 28 and 30, a lens 32, a light source control unit 34, a laser diode (LD) driver 36, a projecting unit 38, a mirror control unit 40, and a mirror driver 42.

The control unit 16 is a central processing unit (CPU) that integrally controls each of the constituent elements of the projector main unit 8. The control unit 16 obtains a position of the operating object 14 in the image 12, based on the detection information from the light receiving unit 10. Specifically, the control unit 16 obtains a position (coordinates) of the operating object 14 in the image 12, by determining at which position on the image 12 the laser light detected by the light receiving unit 10 is scanned, based on temporal information of the laser light detected by the light receiving unit 10 and a trajectory of the scanned laser light.

Furthermore, the control unit 16 obtains a detection time (detected amount) each time one frame of the image 12 is projected based on the detection information from the light receiving unit 10. The detection time is a time during which the light receiving unit 10 detects the laser light while one frame of the image 12 is projected. The control unit 16 determines that the operating object 14 has touched the screen 6, based on change in the obtained detection time. Specifically, the control unit 16 determines that the operating object 14 has touched the screen 6, when the detection time is constant during a first period (for example, while five frames of the image 12 are projected). Furthermore, the control unit 16 determines that the operating object 14 has touched the screen 6, when the detection time is constant during a second period (for example, while two to four frames of the image 12 are projected) shorter than the first period and starts to decrease after the second period. The procedure of the method for determining a touch by the control unit 16 will be described later.

Furthermore, the control unit 16 obtains a detected peak value (detected amount) based on the detection information from the light receiving unit 10, each time one frame of the image 12 is projected. The detected peak value is a peak value of an amount of the laser light detected by the light receiving unit 10 while one frame of the image 12 is projected.

The storage unit 18 stores the detection time obtained by the control unit 16 as data, each time one frame of the image 12 is projected. The storage unit 18 stores detection times corresponding to respective frames of the image 12.

The image processing unit 20 controls projection of the image 12, based on an image signal input from an external device. Specifically, the image processing unit 20 controls, based on the image signal input from the external device, (i) emission of the laser light by the three laser light sources 22, 24, and 26 using the light source control unit 34 and (ii) scanning of the laser light by the projecting unit 38 using the mirror control unit 40.

Each of the three laser light sources 22, 24, and 26 is a LD that emits laser light with a single color component at a particular wavelength. Specifically, the laser light source 22 emits laser light of a red component, the laser light source 24 emits laser light of a green component, and the laser light source 26 emits laser light of a blue component. The laser light emitted from each of the three laser light sources 22, 24, and 26 is, for example, linear polarized laser light.

Each of the dichroic mirrors 28 and 30 has optical properties of reflecting only laser light at a particular wavelength and transmitting laser light at other wavelengths. Specifically, the dichroic mirror 28 reflects only the laser light of the green component, and transmits laser light of other color components. The dichroic mirror 30 reflects only the laser light of the red component, and transmits the laser light of other color components.

The dichroic mirror 28 is disposed upstream of a light path of the laser light, and the dichroic mirror 30 is disposed downstream of the light path of the laser light. The laser light of the green component from the laser light source 24 is reflected from the dichroic mirror 28, and the laser light of the blue component from the laser light source 26 passes through the dichroic mirror 28. Accordingly, the dichroic mirror 28 combines the laser light of the green component and the laser light of the blue component.

The laser light of the red component from the laser light source 22 is reflected from the dichroic mirror 30, and the combined laser light of the green and blue components passes through the dichroic mirror 30. Accordingly, the dichroic mirror 30 combines the laser light of the red component with the laser light of the green and blue components.

The lens 32 is a condenser for condensing the laser light combined by the dichroic mirror 30.

The light source control unit 34 controls emission of the laser light emitted by each of the three laser light sources 22, 24, and 26 by driving the LD driver 36 based on a control signal from the image processing unit 20. Specifically, the light source control unit 34 controls the three laser light sources 22, 24, and 26 so that each of the light sources 22, 24, and 26 emits laser light of a color corresponding to each pixel of the image 12 to match the timing at which the projecting unit 38 scans the laser light.

The projecting unit 38 projects the image 12 onto the screen 6, and includes, for example, a Micro Electro-Mechanical Systems (MEMS) mirror 38a. The MEMS mirror 38a is horizontally scanned at a relatively high speed, and vertically scanned at a relatively low speed. The MEMS mirror 38a reflects the laser light from the lens 32 in a direction corresponding to the deflection angle. With horizontal and vertical scanning of the MEMS mirror 38a, the laser light is horizontally and vertically scanned toward the screen 6, and the image 12 is projected onto the screen 6.

The mirror control unit 40 controls the deflection angle of the MEMS mirror 38a by driving the mirror driver 42 based on the control signal from the image processing unit 20.

### [Method for Determining a Touch]

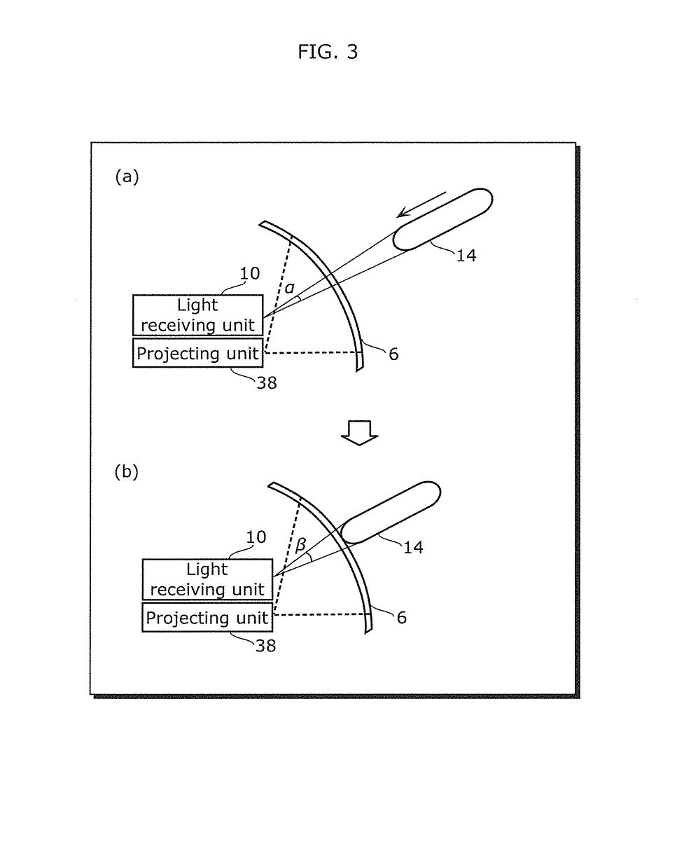

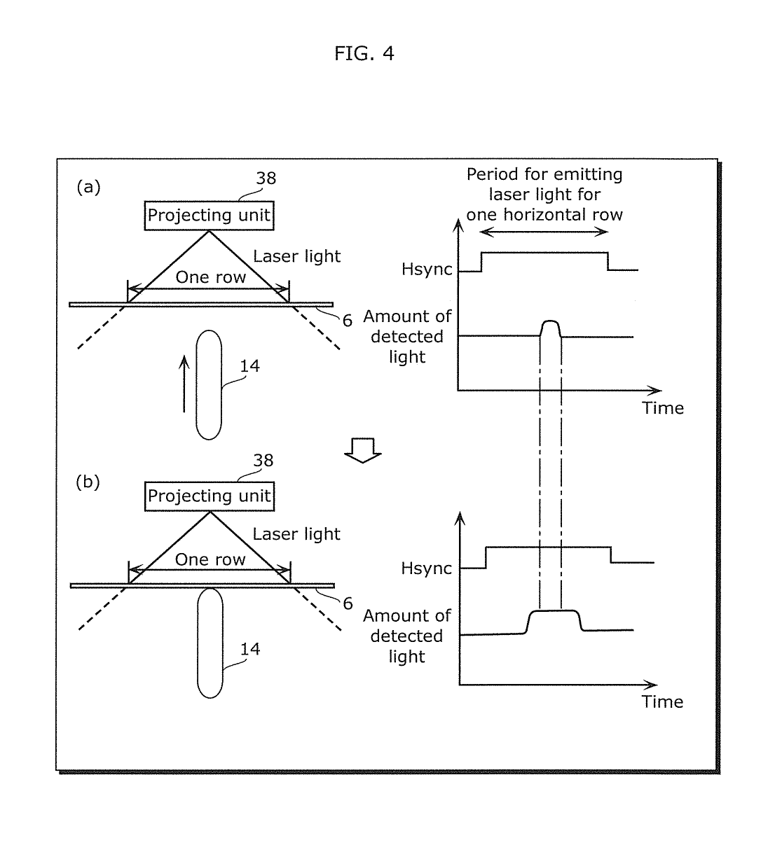

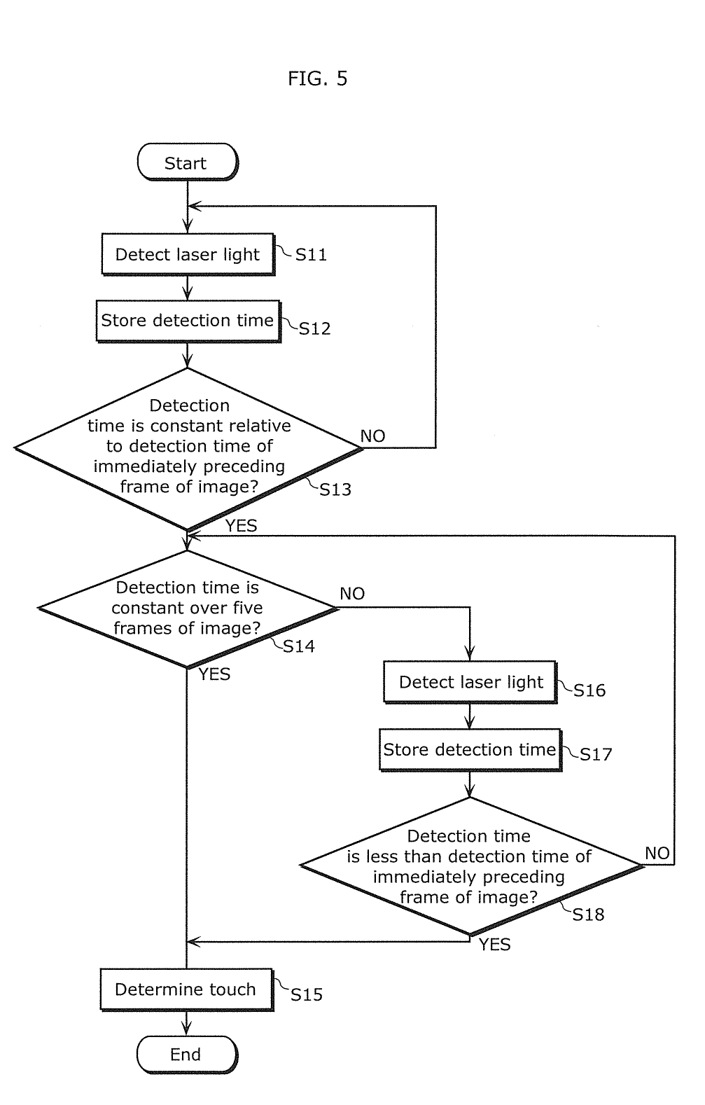

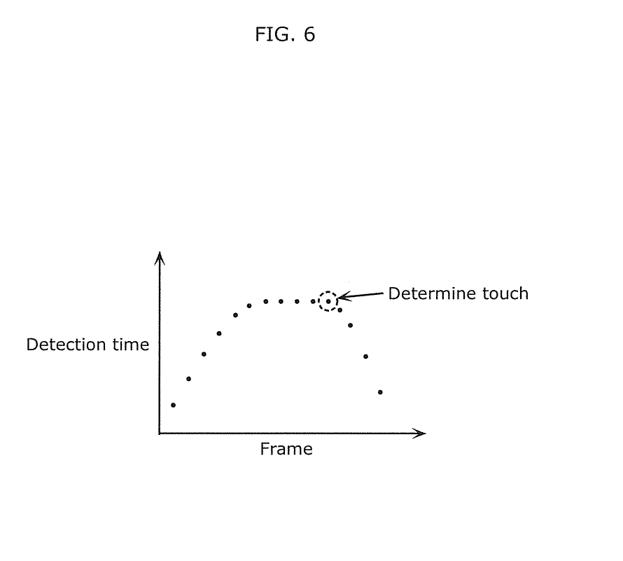

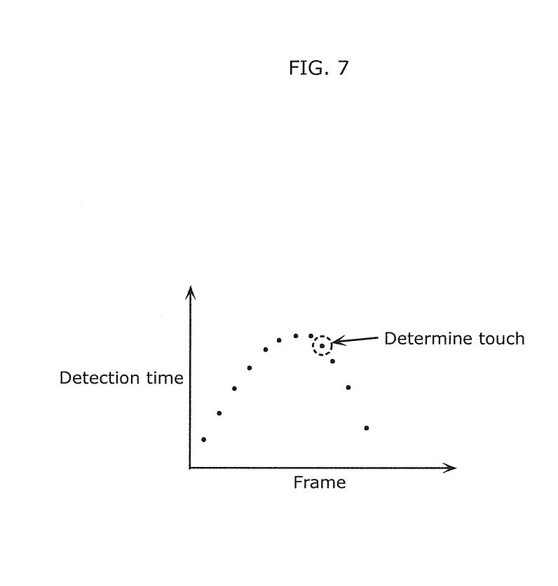

Next, a method for determining a touch by the control unit 16 that is a unique function of the projector 2 according to Embodiment 1 will be described with reference to FIGS. 3 to 7. FIG. 3 schematically illustrates a relationship between moving of the operating object 14 and a detection time. FIG. 4 schematically illustrates a relationship between moving of the operating object 14 and a detected peak value. FIG. 5 is a flowchart indicating procedure of the method for determining a touch by the control unit 16 in the projector 2 according to Embodiment 1. FIG. 6 is a graph indicating a relationship between a frame of an image and a detection time when the detection time is constant during the first period and decreases after the first period. FIG. 7 is a graph indicating a relationship between a frame of an image and a detection time when the detection time is constant during the second period and decreases after the second period.

The relationship between moving of the operating object 14 and the detection time will be described with reference to FIG. 3. When the operating object 14 is distant from the screen 6 as illustrated in (a) of FIG. 3, a denotes an angular range of the laser light detectable by the light receiving unit 10, in the laser light reflected from the operating object 14. In contrast, when the operating object 14 touches the screen 6 as illustrated in (b) of FIG. 3, β (>α) denotes an angular range of the laser light detectable by the light receiving unit 10, in the laser light reflected from the operating object 14.

The angular range increases as the operating object 14 is approaching the screen 6. Since the number of detection of laser light by the light receiving unit 10 increases, the detection time increases. In contrast, the angular range decreases as the operating object 14 is moving away from the screen 6. Since the number of detection of laser light by the light receiving unit 10 decreases, the detection time decreases. Furthermore, the angular range is constant when the operating object 14 touches the screen 6. Since the number of detection of laser light by the light receiving unit 10 is constant, the detection time also becomes constant.

Next, the relationship between moving of the operating object 14 and the detected peak value will be described with reference to FIG. 4. In the projector 2 for rear projection according to Embodiment 1, as the operating object 14 is approaching the screen 6, the distance between the operating object 14 and the light receiving unit 10 becomes shorter. Thus, the detected peak value of the amount of the laser light detected by the light receiving unit 10 increases. Thus, when the operating object 14 is distant from the screen 6 as illustrated (a) of FIG. 4, the detected peak value of the amount of the laser light detected by the light receiving unit 10 relatively decreases. In contrast, when the operating object 14 touches the screen 6 as illustrated (b) of FIG. 4, the detected peak value of the amount of the laser light detected by the light receiving unit 10 is maximized.

Accordingly, the detected peak value increases while the operating object 14 is approaching the screen 6, whereas the detected peak value decreases while the operating object 14 is moving away from the screen 6. Furthermore, the detected peak value is constant when the operating object 14 touches the screen 6.

Next, the procedure of the method for determining a touch by the control unit 16 will be described with reference to FIGS. 5 to 7. Embodiment 1 describes the case where the operating object 14 touches the screen 6 by approaching it, and then moves away from the screen 6.

While the operating object 14 is approaching the screen 6, the light receiving unit 10 detects the laser light reflected from the operating object 14 (S11). The control unit 16 obtains a detection time based on the detection information from the light receiving unit 10, each time one frame of the image 12 is projected. The storage unit 18 stores the detection time obtained by the control unit 16, each time one frame of the image 12 is projected (S12). As indicated in FIG. 6, while the operating object 14 is approaching the screen 6, the detection time increases. When the detection time increases (No at S13), Steps S11 to S13 are repeatedly performed.

As indicated in FIG. 6, when the operating object 14 touches the screen 6, the detection time is constant while the immediately preceding frame of the image 12 is projected onto the screen 6 (Yes at S13). Here, the control unit 16 determines whether or not the period during which the detection time is constant is the first period (for example, while five frames of the image 12 are projected) (S14). As indicated in FIG. 6, when the period during which the detection time is constant is the first period (Yes at S14), the control unit 16 determines that the operating object 14 has touched the screen 6 (S15).

In contrast, when the period during which the detection time is constant is shorter than the first period (No at S14), the laser light is detected and the detection time is stored as at Steps S11 and S12 (S16 and S17). Then, the control unit 16 determines whether or not the detection time is constant during the second period (for example, while two to four frames of the image 12 are projected) and starts to decrease after the second period (S18). As indicated in FIG. 7, when the detection time is constant during the second period and starts to decrease after the second period (Yes at S18), the control unit 16 determines that the operating object 14 has touched the screen 6 (S15).

When the detection time does not start to decrease (No at S18), Step S14 is again performed. Specifically, the control unit 16 continues to determine whether or not the detection time starts to decrease, until the period during which the detection time is constant reaches the first period.

Although the first period is a period during which five frames of the image 12 are projected according to Embodiment 1, the first period is not limited to such but can be arbitrarily set. For example, the first period may be a period during which 10 frames of the image 12 are projected. Although the second period is a period during which two to four frames of the image 12 are projected according to Embodiment 1, the second period is not limited to such but can be arbitrarily set. For example, the second period may be a period during which two to nine frames of the image 12 are projected.

### [Advantages]

Next, advantages of the projector 2 according to Embodiment 1 will be described. When the operating object 14 touches the screen 6, the detection time is constant. As described above, the control unit 16 determines that the operating object 14 has touched the screen 6 when the detection time is constant during the first period. Accordingly, it is possible to prevent erroneous determination of the touch by the control unit 16, for example, while the operating object 14 is approaching the screen 6. As a result, touching of the operating object 14 on the screen 6 can be accurately detected.

Furthermore, as described above, the control unit 16 determines that the operating object 14 has touched the screen 6 when the detection time is constant during the second period and starts to decrease after the second period. Accordingly, it is possible to detect that the operating object 14 has touched the screen 6, when the operating object 14 starts to move away from the screen 6 immediately after touching the screen 6.

### Embodiment 2

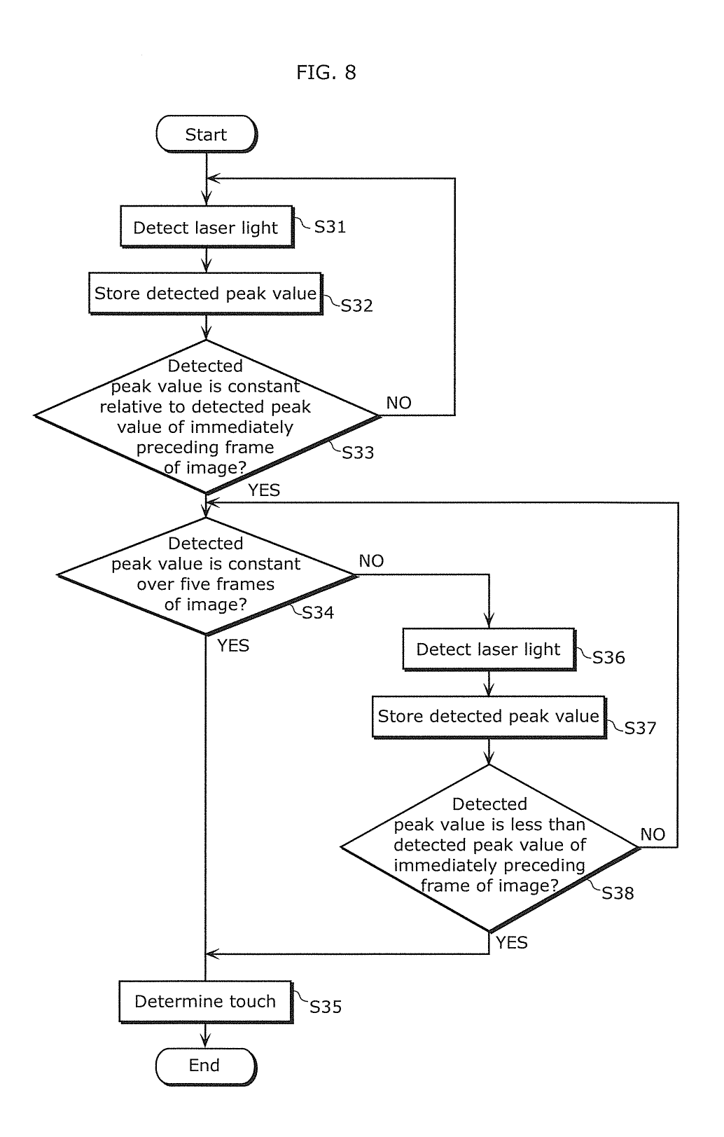

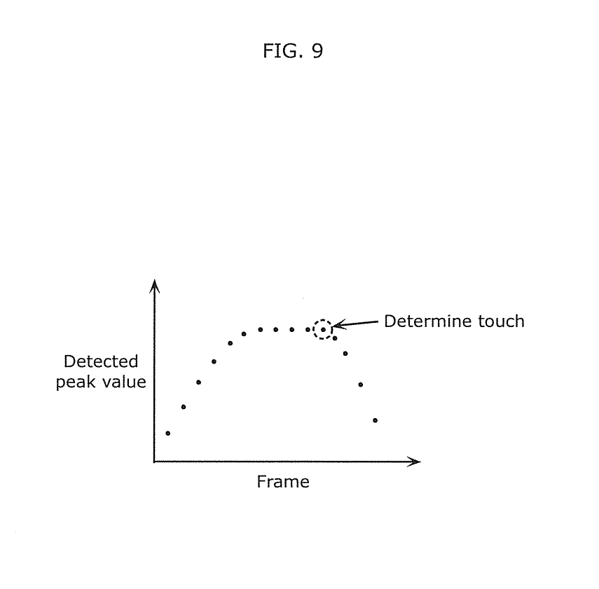

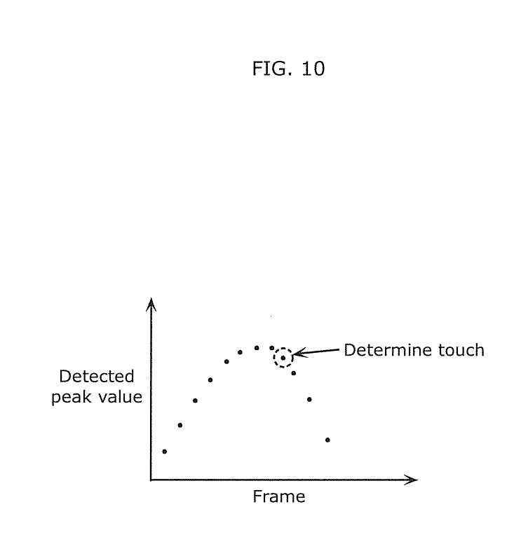

Next, a configuration of the projector 2 according to Embodiment 2 will be described with reference to FIGS. 8 to 10. FIG. 8 is a flowchart indicating procedure of the method for determining a touch by the control unit 16 in the projector 2 according to Embodiment 2. FIG. 9 is a graph indicating a relationship between a frame of an image and a detected peak value when the detection time is constant during the first period and decreases after the first period. FIG. 10 is a graph indicating a relationship between a frame of an image and a detected peak value when the detection time is constant during the second period and decreases after the second period. The description of Embodiments to be described below will be omitted by using the same reference numerals for the same constituent elements as those of Embodiment 1.

Since the projector 2 according to Embodiment 2 has a functional configuration similar to that of the projector 2 according to Embodiment 1, the functional configuration of the projector 2 herein will be described with reference to FIG. 2.

In the projector 2 according to Embodiment 2, the storage unit 18 stores as data the detected peak value obtained by the control unit 16, each time one frame of the image 12 is projected. The storage unit 18 stores detected peak values corresponding to the respective frames of the image 12.

Furthermore, the control unit 16 determines that the operating object 14 has touched the screen 6 based on change in the obtained detected peak value. Specifically, the control unit 16 determines that the operating object 14 has touched the screen 6 when the detected peak value is constant during the first period (for example, while five frames of the image 12 are projected). Furthermore, the control unit 16 determines that the operating object 14 has touched the screen 6 when the detected peak value is constant during the second period (for example, while two to four frames of the image 12 are projected) that is shorter than the first period and starts to decrease after the second period.

Next, the procedure of the method for determining a touch by the control unit 16 will be described with reference to FIGS. 8 to 10. Embodiment 2 describes the case where the operating object 14 touches the screen 6 by approaching it, and then moves away from the screen 6 as described in Embodiment 1.

While the operating object 14 is approaching the screen 6, the light receiving unit 10 detects the laser light reflected from the operating object 14 (S31). The control unit 16 obtains the detected peak value based on the detection information from the light receiving unit 10, each time one frame of the image 12 is projected. The storage unit 18 stores the detected peak value obtained by the control unit 16, each time one frame of the image 12 is projected (S32). As indicated in FIG. 9, while the operating object 14 is approaching the screen 6, the detected peak value increases. When the detected peak value increases (No at S33), Steps S31 to S33 are repeatedly performed.

As indicated in FIG. 9, when the operating object 14 touches the screen 6, the detected peak value is constant relative to the detected peak value obtained when an immediately preceding frame of the image 12 is projected onto the screen 6 (Yes at S33). Here, the control unit 16 determines whether or not the period during which the detected peak value is constant is the first period (for example, while five frames of the image 12 are projected) (S34). As indicated in FIG. 9, when the period during which the detected peak value is constant is the first period (Yes at S34), the control unit 16 determines that the operating object 14 has touched the screen 6 (S35).

In contrast, when the period during which the detected peak value is constant is shorter than the first period (No at S34), the laser light is detected and the detected peak value is stored as at Steps S31 and S32 (S36 and S37). Then, the control unit 16 determines whether or not the detected peak value is constant during the second period (for example, while two to four frames of the image 12 are projected) and starts to decrease after the second period (S38). As indicated in FIG. 10, when the detected peak value is constant during the second period and starts to decrease after the second period (Yes at S38), the control unit 16 determines that the operating object 14 has touched the screen 6 (S35).

When the detected peak value does not start to decrease (No at S38), Step S34 is again performed. Specifically, the control unit 16 continues to determine whether or not the detected peak value starts to decrease until the period during which the detected peak value is constant reaches the first period.

Thus, the projector 2 according to Embodiment 2 can produce the same advantages as Embodiment 1.

### Embodiment 3

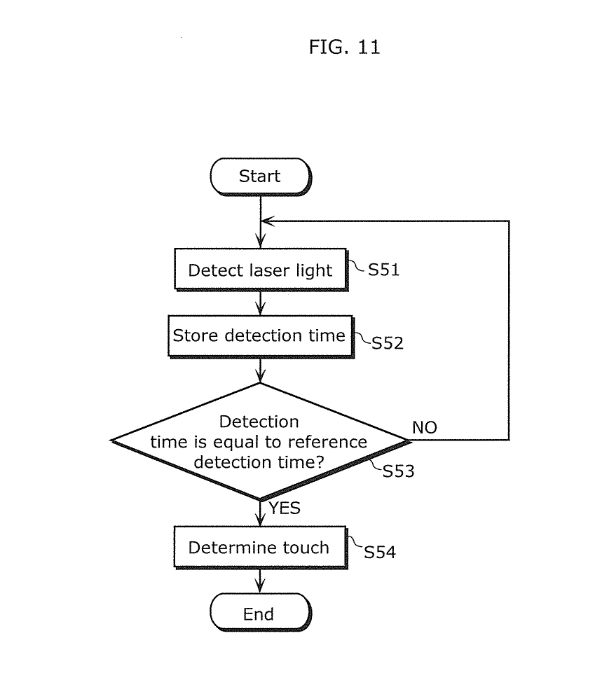

Next, a configuration of the projector 2 according to Embodiment 3 will be described with reference to FIG. 11. FIG. 11 is a flowchart indicating procedure of the method for determining a touch by the control unit 16 in the projector 2 according to Embodiment 3.

Since the projector 2 according to Embodiment 3 has a functional configuration similar to that of the projector 2 according to Embodiment 1, the functional configuration of the projector 2 herein will be described with reference to FIG. 2.

In the projector 2 according to Embodiment 3, the storage unit 18 prestores a reference detection time (for example, 10 to 20 psecs) during which the light receiving unit 10 needs to detect laser light each time one frame of the image 12 is projected, when the operating object 14 (for example, stylus dedicated to the projector 2) touches the screen 6.

The control unit 16 compares an obtained detection time with the reference detection time prestored in the storage unit 18. When the obtained detection time is equal to the reference detection time, the control unit 16 determines that the operating object 14 has touched the screen 6.

Next, the procedure of the method for determining a touch by the control unit 16 will be described with reference to FIG. 11. First, the light receiving unit 10 detects the laser light reflected from the operating object 14 (S51). The control unit 16 obtains a detection time based on the detection information from the light receiving unit 10, each time one frame of the image 12 is projected. The storage unit 18 stores the detection time, each time one frame of the image 12 is projected (S52).

The control unit 16 compares the obtained detection time with the reference detection time (S53). When the obtained detection time is equal to the reference detection time (Yes at S53), the control unit 16 determines that the operating object 14 has touched the screen 6 (S54). When the obtained detection time is not equal to the reference detection time (No at S53), the control unit 16 determines that the operating object 14 does not touch the screen 6 and Step S51 is again performed.

Thus, the projector 2 according to Embodiment 3 can produce the same advantages as Embodiment 1.

### Embodiment 4

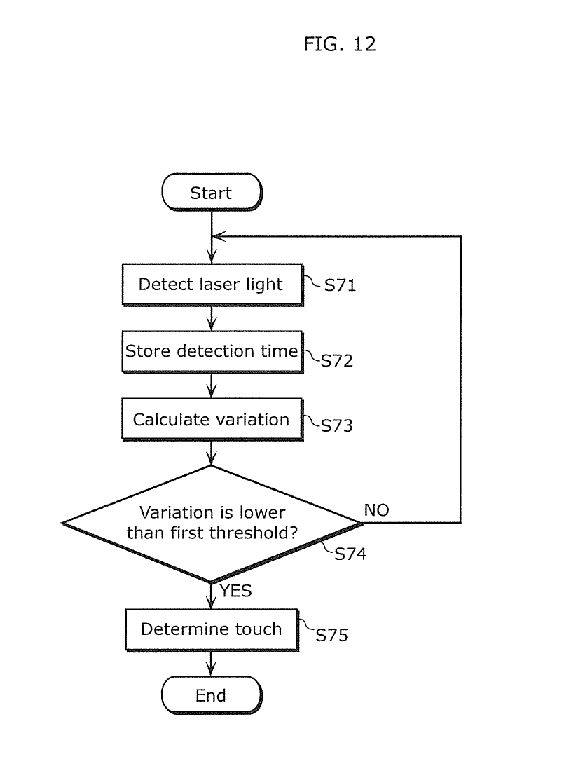

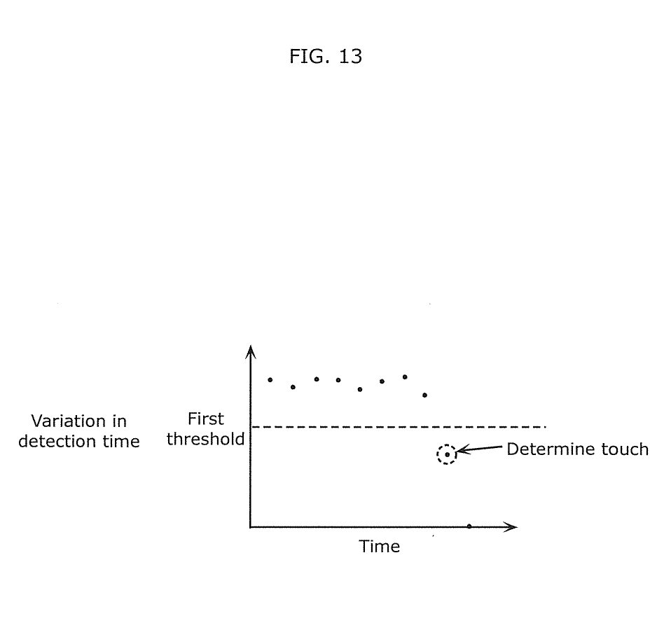

Next, a configuration of the projector 2 according to Embodiment 4 will be described with reference to FIGS. 12 and 13. FIG. 12 is a flowchart indicating procedure of the method for determining a touch by the control unit 16 in the projector 2 according to Embodiment 4. FIG. 13 is a graph indicating a temporal variation in detection time.

Since the projector 2 according to Embodiment 4 has a functional configuration similar to that of the projector 2 according to Embodiment 1, the functional configuration of the projector 2 herein will be described with reference to FIG. 2.

In the projector 2 according to Embodiment 4, the control unit 16 calculates a variation in detection time, based on the detection times stored in the storage unit 18 each time one frame of the image 12 is projected. The variation in the detection time indicates a difference between a detection time corresponding to a particular frame of the image 12 and a detection time corresponding to a frame immediately preceding the particular frame of the image 12. Furthermore, the control unit 16 determines that the operating object 14 has touched the screen 6, when the obtained variation in the detection time is lower than a first threshold (predetermined threshold).

Next, the procedure of the method for determining a touch by the control unit 16 will be described with reference to FIGS. 12 and 13. First, the light receiving unit 10 detects the laser light reflected from the operating object 14 (S71). The control unit 16 obtains a detection time based on the detection information from the light receiving unit 10, each time one frame of the image 12 is projected. The storage unit 18 stores the detection time, each time one frame of the image 12 is projected (S72).

Then, the control unit 16 calculates a variation in the detection time, based on the detection times stored in the storage unit 18 (S73). As indicated in FIG. 13, when the operating object 14 is approaching the screen 6, the temporal variation in the detection time remains almost unchanged. However, when the operating object 14 touches the screen 6, the variation in detection time abruptly decreases to 0. Thus, when the variation in the detection time is lower than the first threshold (Yes at S74), the control unit 16 determines that the operating object 14 has touched the screen 6 (S75).

When the variation in the detection time is not lower than the first threshold (No at S74), the control unit 16 determines that the operating object 14 does not touch the screen 6 and Step S71 is again performed.

Thus, the projector 2 according to Embodiment 4 can produce the same advantages as Embodiment 1.

### Embodiment 5

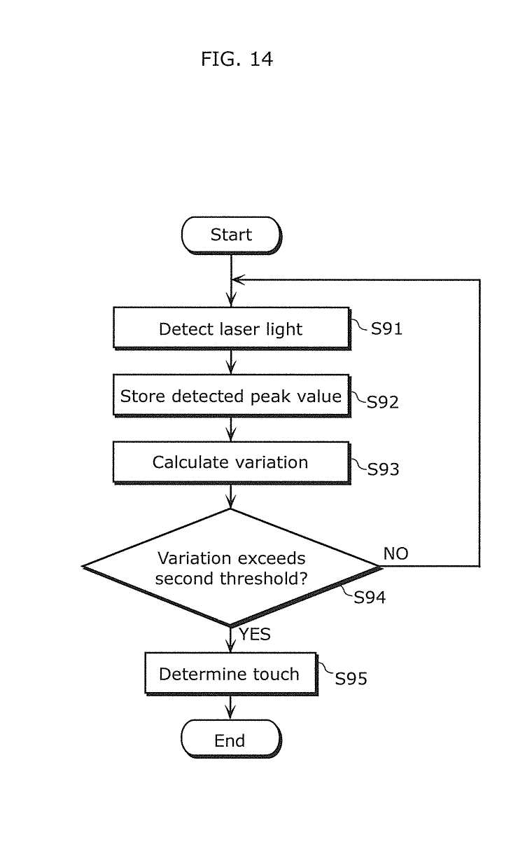

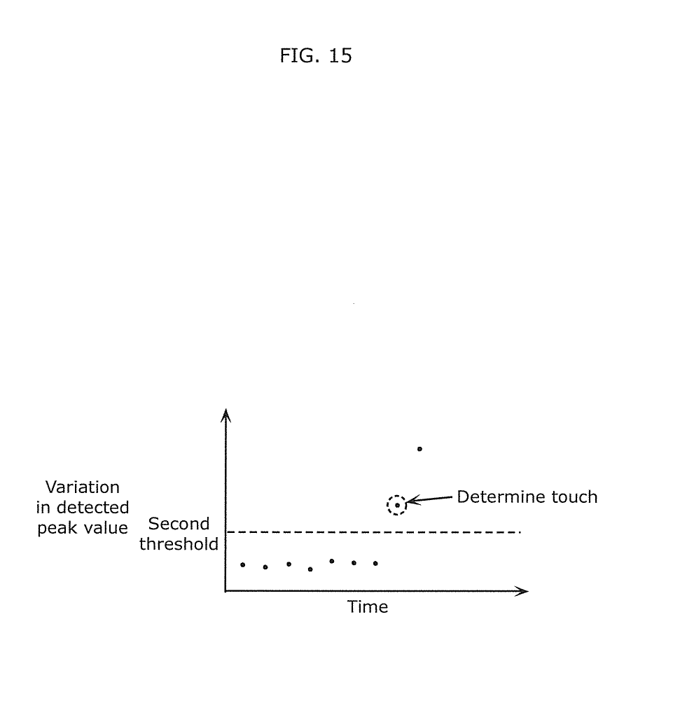

Next, a configuration of the projector 2 according to Embodiment 5 will be described with reference to FIGS. 14 and 15. FIG. 14 is a flowchart indicating procedure of the method for determining a touch by the control unit 16 in the projector 2 according to Embodiment 5. FIG. 15 is a graph indicating the temporal variation in the detected peak value.

Since the projector 2 according to Embodiment 5 has a functional configuration similar to that of the projector 2 according to Embodiment 1, the functional configuration of the projector 2 herein will be described with reference to FIG. 2.

In the projector 2 according to Embodiment 5, the control unit 16 calculates a variation in the detected peak value based on the detected peak values stored in the storage unit 18, each time one frame of the image 12 is projected. The variation in the detected peak value indicates a difference between a detected peak value corresponding to a particular frame of the image 12 and a detected peak value corresponding to a frame immediately preceding the particular frame of the image 12. The control unit 16 determines that the operating object 14 has touched the screen 6, when the obtained variation in the detected peak value exceeds the second threshold (predetermined threshold).

Next, the procedure of the method for determining a touch by the control unit 16 will be described with reference to FIGS. 14 and 15. First, the light receiving unit 10 detects the laser light reflected from the operating object 14 (S91). The control unit 16 obtains a detected peak value based on the detection information from the light receiving unit 10, each time one frame of the image 12 is projected. The storage unit 18 stores the detected peak value, each time one frame of the image 12 is projected (S92).

Then, the control unit 16 calculates a variation in the detected peak value, based on the detected peak values stored in the storage unit 18 (S93). As indicated in FIG. 15, when the operating object 14 is approaching the screen 6, the temporal variation in the detected peak value remains almost unchanged. However, when the operating object 14 touches the screen 6, the variation in the detected peak value abruptly increases due to increase in instantaneous incidence of the laser light reflected from the operating object 14 to the light receiving unit 10. Thus, when the variation in the detected peak value exceeds the second threshold (Yes at S94), the control unit 16 determines that the operating object 14 has touched the screen 6 (S95).

When the variation in the detected peak value does not exceed the second threshold (No at S94), the control unit 16 determines that the operating object 14 does not touch the screen 6 and Step S91 is again performed.

Thus, the projector 2 according to Embodiment 5 can produce the same advantages as Embodiment 1.

Although the projectors according to Embodiments 1 to 5 of the present invention are described hereinbefore, the present invention is not limited to these embodiments. For example, these embodiments may be combined.

The projector according to each of Embodiments 1 to 5 is a rear projection projector. Not limited to this, the projector may be a front projection projector in which, for example, the projector main unit, the light receiving unit, and the operating object are disposed in front of the screen 6.

The projector according to each of Embodiments 1 to 5 may be a computer system specifically including a microprocessor, a read-only memory (ROM), a random access memory (RAM), a hard disk drive, a display unit, a keyboard, and a mouse. The RAM or the hard disk drive stores a computer program. The microprocessor operates according to the computer program, so that each of the projectors fulfills the functions. Here, the computer program is a combination of instruction codes each indicating an instruction to a computer to implement a predetermined function.

A part of or an entire of the constituent elements included in each of the projectors may be configured of a system Large Scale Integration (LSI). The system LSI is a super multi-functional LSI manufactured by integrating the constituent elements into a single chip. More specifically, the system LSI is a computer system including a microprocessor, a ROM, and a RAM. The RAM stores a computer program. The microprocessor operates according to the computer program, so that the system LSI fulfills the functions.

Furthermore, a part or an entire of the constituent elements included in each of the projectors may be configured of an IC card or a single module detachable from the projector. The IC card or the module is a computer system including the microprocessor, the ROM, and the RAM. The IC card or the module may include the super multi-functional LSI. The microprocessor operates according to the computer program, so that each of the IC card and the module fulfills the functions. The IC card or the module may have tamper-resistance.

The present invention may be implemented by any of the above methods. Furthermore, these methods may be implemented by causing a computer to execute a computer program, and by a digital signal included in the computer program according to the present invention.

Moreover, the present invention may be implemented by recording the computer program or the digital signal on non-transitory computer-readable recording media, for example, a flexible disk, a hard disk, a CD-ROM, an MO, a DVD, a DVD-ROM, a DVD-RAM, a Blu-ray Disc (BD) (R), and a semiconductor memory. Moreover, the present invention may be implemented by the digital signal recorded on these non-transitory recording media.

Moreover, the present invention may be implemented by transmitting the computer program or the digital signal via, for example, an electronic communication line, a wireless or wired communication line, a network represented by the Internet, or data broadcasting.

Moreover, the present invention may be a computer system including a microprocessor and a memory. The memory may store the computer program, and the microprocessor may operate according to the computer program.

Furthermore, the present invention may be implemented by another independent computer system by recording the computer program or the digital signal on the non-transitory recording media and transporting the recording media, or by transmitting the computer program or the digital signal via a network.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable as a projector and others that project an image on a projection screen and detect a touch of the operating object on the projection screen.

1. A projector that projects an image onto a projection screen, and detects a touch of an operating object on the projection screen, the projector comprising:
a light source that emits laser light;
a projecting unit configured to project the image onto the projection screen by scanning the laser light from the light source toward the projection screen;
a light receiving unit configured to detect the laser light reflected from the operating object; and
a control unit configured to determine that the operating object has touched the projection screen, based on change in the laser light detected by the light receiving unit.

2. The projector according to claim 1,
wherein the control unit is configured to obtain an amount of the laser light detected by the light receiving unit, and determine that the operating object has touched the projection screen when the detected amount is constant during a first period.

3. The projector according to claim 2,
wherein the control unit is further configured to determine that the operating object has touched the projection screen, when the detected amount is constant during a second period shorter than the first period and starts to decrease after the second period.

4. The projector according to claim 2,
wherein the detected amount includes a detection time during which the light receiving unit detects the laser light per frame of the image.

5. The projector according to claim 2,
wherein the detected amount includes a peak value of an amount of the laser light detected by the light receiving unit per frame of the image.

6. The projector according to claim 1, further comprising
a storage unit configured to prestore a reference detection time during which the light receiving unit is to detect the laser light per frame of the image, when the operating object touches the screen,
wherein the control unit is configured to obtain a detection time during which the light receiving unit detects the laser light per frame of the image, and determine that the operating object has touched the projection screen when the obtained detection time is equal to the reference detection time prestored by the storage unit.

7. The projector according to claim 1,
wherein the control unit is configured to obtain a variation in amount of the laser light detected by the light receiving unit, and determine that the operating object has touched the projection screen based on a comparison between the obtained variation in the detected amount and a predetermined threshold.

8. The projector according to claim 7,
wherein the detected amount includes a detection time during which the light receiving unit detects the laser light per frame of the image, and
the control unit is configured to obtain a variation in the detection time, and determine that the operating object has touched the projection screen when the obtained variation in the detection time is lower than the predetermined threshold.

9. The projector according to claim 7,
wherein the detected amount includes a peak value of an amount of the laser light detected by the light receiving unit per frame of the image, and
the control unit is configured to obtain a variation in the detected peak value, and determine that the operating object has touched the projection screen when the obtained variation in the detected peak value exceeds the predetermined threshold.
